(19) United States
(12) Patent Application Publication
(10) Pub. No.: US 2014/0059277 A1
(43) Pub. Date: Feb. 27, 2014

(54) STORAGE FOR ADAPTIVELY DETERMINING A PROCESSING TECHNIQUE WITH RESPECT TO A HOST REQUEST BASED ON PARTITION DATA AND OPERATING METHOD FOR THE STORAGE DEVICE

(71) Applicant: INDILINX CO., LTD., Gyeonggi-do (KR)

(72) Inventor: Hyun Mo Chung, Gyeonggi-do (KR)

(73) Assignee: INDILINX CO., LTD., Gyeonggi-do (KR)

(21) Appl. No.: 13/978,276

(22) PCT Filed: Jan. 11, 2012
(86) PCT No.: PCT/KR2012/000254

§ 371 Date: Nov. 7, 2013

(30) Foreign Application Priority Data
Jan. 13, 2011 (KR) 10-2011-0003595

(51) Int. Cl. G06F 12/02

(52) U.S. Cl. CPC G06F 12/0246
USPC 711/103

(57) ABSTRACT

Provided are: a storage device for adaptively determining a processing technique with respect to a host request based on partition data; and an operating method for the storage device. The storage device responds to receipt of a read or write request from a host by ascertaining a partition corresponding to the host request based on data about block addresses occupied by various partitions stored in the storage device. Also, the storage device adaptively determines a processing technique with respect to the host request based on predetermined attributes of the partition concerned.

### TECHNICAL FIELD

The present invention relates to an internal operation scheme of a storage device using a flash memory such as a solid state disk (SSD) and an interaction scheme between the storage device and a host. More particularly, the present invention relates to a storage device for adaptively determining a processing scheme of a request from a host based on partition information and a method of operating the storage device.

### BACKGROUND ART

A solid state disk (SSD) provides, to an external host connected to the SSD, a plurality of blocks that are identified by a block address (BA). In response to a write request including a block address and data being received from the host, the SSD stores the corresponding data in a corresponding block. Also, in response to a read request including a block address being received from the host, the SSD transmits data present in a corresponding block to the host.

An operation system (OS) of the host divides a storage space of the SSD into at least one partition, and stores, in the SSD, a partition table representing a block address from which each partition starts, and a size of each partition, that is, a number of blocks. However, the SSD only stores the partition table, and does not inspect the content of the partition table. Accordingly, when the SSD receives a read or write request from the host, the SSD cannot determine a partition to which a block address corresponding to the request belongs. As a result, an internal operation scheme of the SSD in response to the request from the host may be applied equally to all the partitions.

If performance, for example, a data reliability, a processing speed, and a capacity differs for each partition, an efficient use of a SSD may be achieved. However, the method described in the foregoing does not provide an SSD with different performances for each partition to a user.

### DISCLOSURE OF INVENTION

### Technical Goals

Exemplary embodiments of the present invention provide a storage device that may determine, in response to a read or write request being received from a host, a partition corresponding to the request based on information associated with block addresses occupied for each partition, and may adaptively determine a processing scheme of the request based on an attribute of the corresponding partition.

### Technical Solutions

According to an aspect of the present invention, there is provided a method of operating a storage device in a storage system including a host and the storage device provided with at least one disk, the method including storing information associated with an attribute for each of at least one partition of the at least one disk, determining a partition to which a block address corresponding to a read or write request received from the host belongs among the at least one partition, and adaptively determining a processing scheme of the read or write request based on an attribute of the partition to which the block address corresponding to the read or write request belongs.

The method may further include pre-storing information associated with block addresses occupied by each of the at least one partition.

The pre-storing of the information associated with the block addresses occupied by each of the at least one partition may include, in a case in which a write request to a partition table is received, obtaining the information associated with the block addresses for each of the at least one partition based on data recorded corresponding to the write request to the partition table.

The storing of the information associated with the attribute of each for the at least one partition of the at least one disk may include receiving user settings associated with the attribute for each of the at least one partition from the host.

The information associated with the attribute for each of the at least one partition may include information associated with a weight value assigned to at least one of a data reliability, a processing speed, and a capacity for each of the at least one partition information.

The adaptively determining of the processing scheme of the read or write request may include determining whether to replicate and store data corresponding to the write request in different two locations of the partition to which the block address corresponding to the write request belongs, based on a weight value for a data reliability of the partition to which the block address corresponding to the write request belongs.

The adaptively determining of the processing scheme of the read or write request may include, in a case in which the storage device comprises an MLC flash memory, determining whether to operate the MLC flash memory in a single level cell (SLC) mode or an MLC mode, based on a weight value for a data reliability and a processing speed of the partition to which the block address corresponding to the read or write request belongs.

The adaptively determining of the processing scheme of the read or write request may include determining an address mapping scheme based on a weight value for sequential read and write and random read and write of the partition to which the block address corresponding to the read or write request belongs.

According to another aspect of the present invention, there is provided a storage device in a storage system including a host and the storage device provided with at least one disk, the storage device including a storage module to store information associated with an attribute for each of at least one partition of the at least one disk, and a control module to determine a partition to which a block address corresponding to a read or write request received from the host belongs among the at least one partition, and to adaptively determine a processing scheme of the read or write request based on an attribute of the partition to which the block address corresponding to the read or write request belongs.

The storage module may pre-store information associated with block addresses occupied by each of the at least one partition.

The storage module may obtain, when a write request to a partition table is received, the information associated with the block addresses for each of the at least one partition based on data recorded corresponding to the write request to the partition table.

The storage module may receive user settings associated with the attribute for each of the at least one partition from the host.

The information associated with the attribute for each of the at least one partition may include information associated with a weight value assigned to at least one of a data reliability, a processing speed, and a capacity for each of the at least one partition information.

The control module may determine whether to replicate and store data corresponding to the write request in different two locations of the partition to which the block address corresponding to the write request belongs, based on a weight value for a data reliability of the partition to which the block address corresponding to the write request belongs.

The control module may determine, in a case in which the storage device comprises an MLC flash memory, whether to operate the MLC flash memory in an SLC mode or an MLC mode, based on a weight value for a data reliability and a processing speed of the partition to which the block address corresponding to the read or write request belongs.

The control module may determine an address mapping scheme based on a weight value for sequential read and write and random read and write of the partition to which the block address corresponding to the read or write request belongs.

### Effects of the Invention

The storage device according to an exemplary embodiment of the present invention, for example, a solid state disk (SSD), may recognize, in response to a read or write request being received from a host, a partition to which a block address corresponding to the request belongs, based on information associated with block addresses occupied for each partition stored in the storage device, and may adaptively determine a processing scheme of the request based on information associated with an attribute of the corresponding partition, for example, weight values for a data reliability, a speed, and a capacity, stored in the storage device. Accordingly, the storage device may determine an optimal method of processing the request from the host by receiving only the block address without receiving separate information from the host.

The storage device according to an exemplary embodiment of the present invention may store information associated with attributes of partitions preset by a user and the like, and may adaptively determine a processing method based on the attributes of the partitions, so that the storage device may operate to allow different performances for each partition. Accordingly, a user may use the partitions for different purposes based on the attributes of the partitions.

### BRIEF DESCRIPTION OF DRAWINGS

FIG. 1 is a block diagram illustrating a storage system according to an exemplary embodiment of the present invention.

FIG. 2 is a diagram illustrating an internal operation scheme of a solid state disk (SSD) based on an attribute considered as an important factor in a flash memory.

FIG. 3 is a block diagram illustrating a controller according to an exemplary embodiment of the present invention.

FIG. 4 is a diagram illustrating partitions into which disks of an SSD are divided and block addresses according to an exemplary embodiment of the present invention.

FIG. 5 is a flowchart illustrating a method of operating a storage device provided with at least one disk in a storage system including the storage device and a host according to an exemplary embodiment of the present invention.

### BEST MODE FOR CARRYING OUT THE INVENTION

Hereinafter, exemplary embodiments of the present invention are described in detail with reference to the accompanying drawings.

In the description of the exemplary embodiments of the present invention, descriptions of well-known functions or components are omitted so as to not unnecessarily obscure the embodiments herein. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein. Hence, the terms must be interpreted based on the contents of the entire specification.

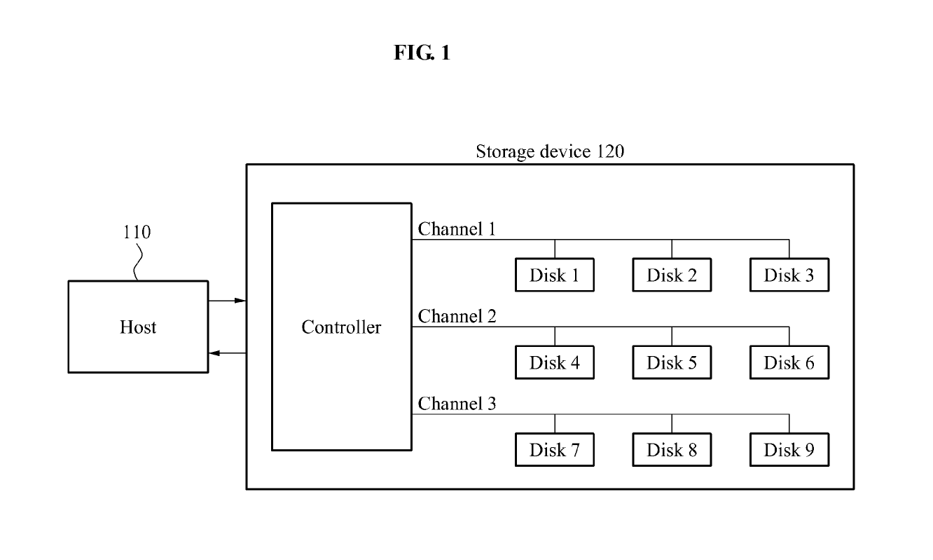

FIG. 1 is a block diagram illustrating a storage system according to an exemplary embodiment of the present invention.

Referring to FIG. 1, the storage system according to an exemplary embodiment of the present invention may include a host 110 and a storage device 120.

The storage device 120 may include a controller and a plurality of disks, for example, disks 1 through 9, connected to a plurality of channels, for example, channels 1 through 3.

The controller and the host 110 may transmit and receive signals through a controller interface and a host interface. More particularly, the controller may receive, from the host interface, a read or write request from the host 110 through the controller interface. Also, the controller may control a read or write operation of the plurality of disks in response to the read or write request being received form the host 110.

The disk may include a magnetic disk or a solid state semiconductor disk, and the semiconductor disk may include a non-volatile memory or a volatile memory. An example of a non-volatile memory may include a flash memory such as a negated AND (NAND) flash and an NOR flash.

Here, a flash memory may be installed in each of the plurality of disks, and in this case, the storage device 120 may correspond to a solid state disk (SSD).

The plurality of disks may be connected to the plurality of independent channels, for example, channels 1 through 3. Also, the controller may control a read or write operation of the plurality of disks connected to each of the plurality of channels.

The plurality of channels may be operated independently from one another. Accordingly, the storage device 120 according to an exemplary embodiment of the present invention may perform a read or write operation in parallel using the plurality of channels operating independently from one another. That is, the controller may control a read or write operation independently over a disk 1, a disk 2, and a disk 3 connected to the channel 1, a disk 4, a disk 5, and a disk 6 connected to the channel 2, and a disk 7, a disk 8, and a disk 9 connected to the channel 3.

Also, the plurality of disks may be divided into at least one partition. The host may transmit, to the storage device 120, a partition table representing a block address occupied by the at least one partition and a size of each partition, that is, a number of blocks, and the storage device 120 may store the partition table in a particular disk.

The storage device according to an exemplary embodiment of the present invention may be also applied to different types of devices as well as an SSD, however for convenience of description, the following description is based on a case in which the storage device corresponds to an SSD.

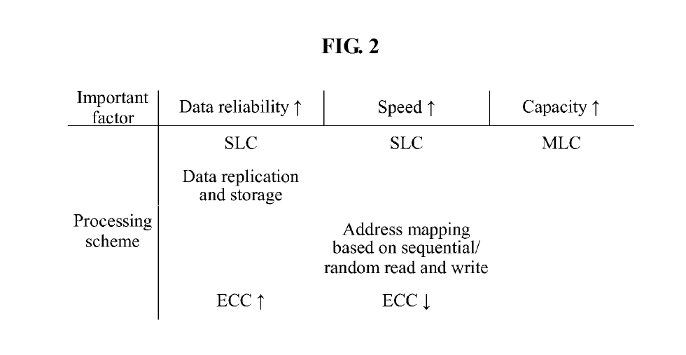

A flash memory used as a storage medium of an SSD may be adjusted, in regard of a data reliability, a speed, and a storage capacity, based on an internal operation scheme of the SSD. A specific operation scheme is described through FIG. 2.

FIG. 2 is a diagram illustrating an internal operation scheme of an SSD based on an attribute considered as an important factor in a flash memory.

Referring to FIG. 2, when a flash memory operates in a single level cell (SLC) mode, a high data reliability and a high processing speed may be ensured, but a high storage capacity may not be ensured. In contrast, when a flash memory operates in a multi level cell (MLC) mode, a data reliability and a speed may be lower than those of SLC, but a high storage capacity may be ensure.

To improve data reliability, a method in which same data is replicated and stored in a flash memory may be contemplated. More particularly, when an SSD processes a write request from a host, the SSD may replicate and store corresponding data in different locations of a flash memory. Accordingly, a probability of data loss may be reduced. However, because data is replicated and stored, a high storage capacity may not be ensured.

Also, with regard to a processing speed, each of a sequential read/write speed and a random read/write speed may be changed based on an address mapping scheme. Accordingly, one of the sequential read/write speed and the random read/write speed may be improved by determining an address mapping scheme properly.

Also, an attribute may be changed based on an error correcting code (ECC). When an ECC having a high correction capability is used, data reliability may be improved but a processing speed may be reduced, and in contrast, when an ECC having a low correction capability is used, data reliability may be reduced but a processing speed may be improved.

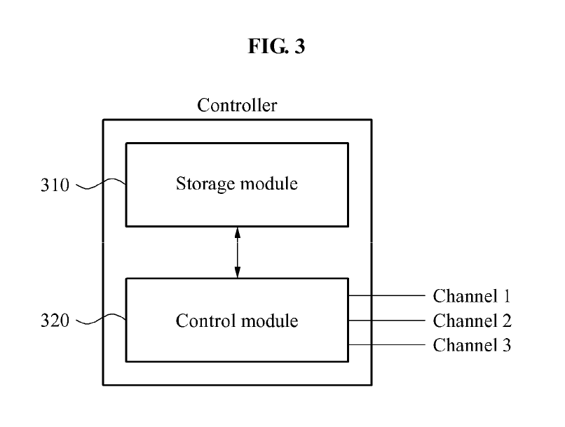

A user may set an attribute of each partition, that is, an importance for a data reliability, a speed, and a capacity, to set a characteristic of a flash memory independently for each partition based on an operation scheme. Also, information associated with the attributes of the partitions may be transmitted from a host to an SSD. The SSD may store the information associated with the attributes of the partitions, when a read or write request is received from the host, may adaptively determine a processing scheme of the request by referring to information associated with an attribute of a corresponding partition. This operation may be performed by a controller of the SSD, and a specific structure and operation of the controller is described through FIG. 3.

FIG. 3 is a block diagram illustrating a controller according to an exemplary embodiment of the present invention.

Referring to FIG. 3, the controller according to an exemplary embodiment of the present invention may include a storage module 310 and a control module 320.

The storage module 310 may store information associated with an attribute of each partition of an SSD. Here, the attribute of the partition may include information associated with a weight value assigned to a data reliability, a processing speed, and a capacity, as described in the foregoing.

More particularly, a user may set an attribute of each partition, and the storage module 310 may receive and store the user settings for the attributes of the partitions from a host.

Also, the storage module 310 may pre-store information associated with block addresses occupied by each partition. The information associated with the block addresses may include information associated with a start block of each partition a size of each partition, that is, a number of blocks. More particularly, when the storage module 310 receives, from the host, a write request to a partition table, for example, a write request to a master boot record (MBR) or a block address 0, the storage module 310 may obtain and store information associated with the block addresses of the partitions based on data recorded corresponding to the write request.

The control module 320 may determine, in response to the read or write request being received from the host, a partition to which a block address corresponding to a read or write request belongs. More particularly, a read request from the host may include a corresponding block address, and a write request from the host may include a corresponding block address and data. Accordingly, when the control module 320 receives a read or write request from the host, the control module 320 may determine a partition to which a block address included in the request belongs, based on the information associated with the block addresses of the partitions stored in the storage module 310.

Also, after the control module 320 determines the partition to which the block address corresponding to the read or write request belongs, the control module 320 may adaptively determine a processing scheme of the read or write request from the host based on an attribute of the corresponding partition stored in the storage module 320. That is, the control module 320 may process the read or write request from the host using a processing scheme enabling a performance considered as an important factor in the corresponding partition to be made higher performance.

Accordingly, the SSD including the controller according to an exemplary embodiment of the present invention may only receive information associated with a block address without receiving, from a host, partition information corresponding to a read or write request or information associated with an attribute of a corresponding partition each time the read or write request is received from the host. Also, the SSD may determine a partition to which a corresponding block address belongs based on the received block address, and may adaptively determine a processing scheme based on an attribute of the corresponding partition. Accordingly, the SSD according to an exemplary embodiment of the present invention may determine an optimal operation scheme for the request from the host without relying on prediction or statistics.

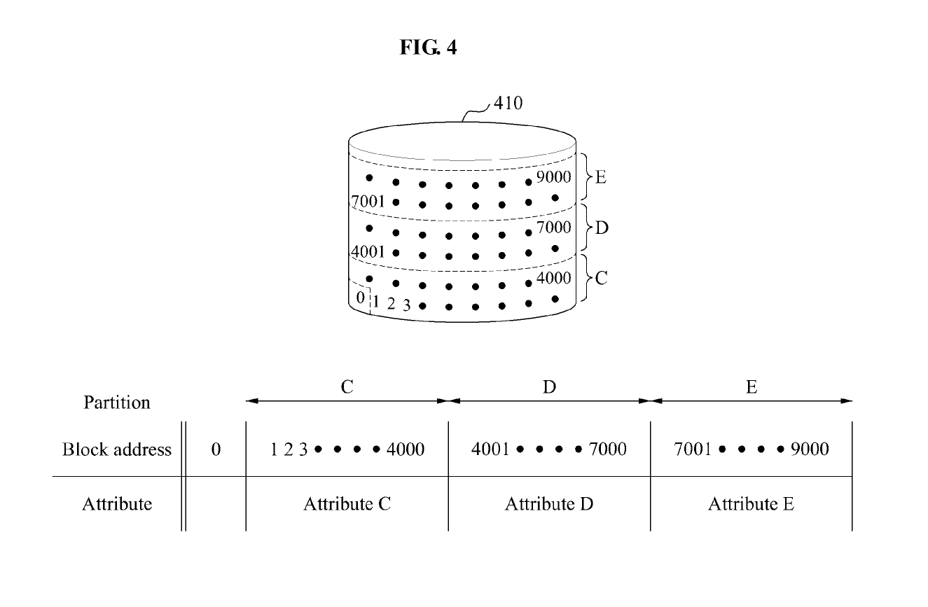

FIG. 4 is a diagram illustrating partitions into which disks of an SSD are divided and block addresses according to an exemplary embodiment of the present invention.

Referring to FIG. 4, disks included in the SSD may have block addresses. As described in the foregoing, a user may generate partitions by partitioning the disks. FIG. 4 illustrates an example of a collection 410 of logical block addresses in which blocks 1 through 4000 are set to a partition C, blocks 4000 through 7000 are set to a partition D, and blocks 7001 through 9000 are set to a partition E among the blocks of the disks.

In a block 0, that is, an MBR, a partition table representing a block address from which each partition starts and a size of each partition, that is, a number of blocks, may be stored. When the SSD receives a write request to the block 0 from a host, the SSD may obtain information associated with block addresses occupied by each partition through analysis of corresponding data.

Hereinafter, provided are examples of adaptively determining a method of processing a request from a host based on attributes, for example, attributes C through E corresponding to partitions, for example, partitions C through E.

1) A first case corresponds to a case in which a partition C is set to sacrifice a speed and a storage capacity instead of maximizing data reliability, and attributes of partitions D and E are not designated.

In a case in which a write request to the partition C is received, the SSD may replicate and store corresponding data in different locations, that is, different two block addresses, of disks, that is, flash memories, belonging to the partition C. For example, in a case in which a block address corresponding to the write request from the host is 1001, the SSD may determine that the corresponding request is associated with the partition C and may replicate and store corresponding data in different physical locations of a storage medium. Accordingly, a probability of data loss may be reduced.

In contrast, in a case in which a write request to the partition D or E is received, the SSD may store corresponding data without replication.

2) A second case corresponds to a case in which the SSD includes both an SLC flash memory and an MLC flash memory, a partition C is set to consider a data reliability and a speed as an important factor, and a partition D is set to consider an available storage capacity as an important factor. In this case, the SSD may operate the SLC flash memory when a read or write request from the host is associated with the partition C, and may operate the MLC flash memory when a read or write request from the host is associated with the partition D, thereby operating to suit attributes of the partitions C and C being set by a user.

3) A third case corresponds to a case in which the SSD includes an MLC flash memory, a partition C is set to consider a reliability and a speed as an important factor, and a partition D is set to consider an available storage capacity as an important factor. In this case, the SSD may operate a portion of a space of the MLC flash memory in an SLC mode when a read or write request from the host is associated with the partition C, and may operate the remaining space of the MLC flash memory in an MLC mode when a read or write request from the host is associated with the partition D. That is, the requirements of partitions having different attributes may be satisfied by adaptively selecting an operation method of the SSD among an MLC mode and an SLC mode.

4) A fourth case corresponds to a case in which a partition C is set to be optimized for sequential read and write and a partition D is set to be optimized for random read and write. In this case, the SSD may operate to suit an attribute of each partition by using different address mapping schemes based on the request from the host for each partition.

5) A fifth case corresponds to a case in which a partition C is set to consider a data reliability as an important factor and a partition D is set to consider a speed as an important factor.

In this case, the SSD may operate to use an ECC having a high correction capability when a request for the partition C is received from a host, and an ECC having a low correction capability when a request for the partition D is received. Accordingly, the SSD may operate to satisfying the settings associated with a reliability and a speed for each partition.

The exemplary embodiments of the present invention may be applied to other processing methods that operate to suit attributes of partitions.

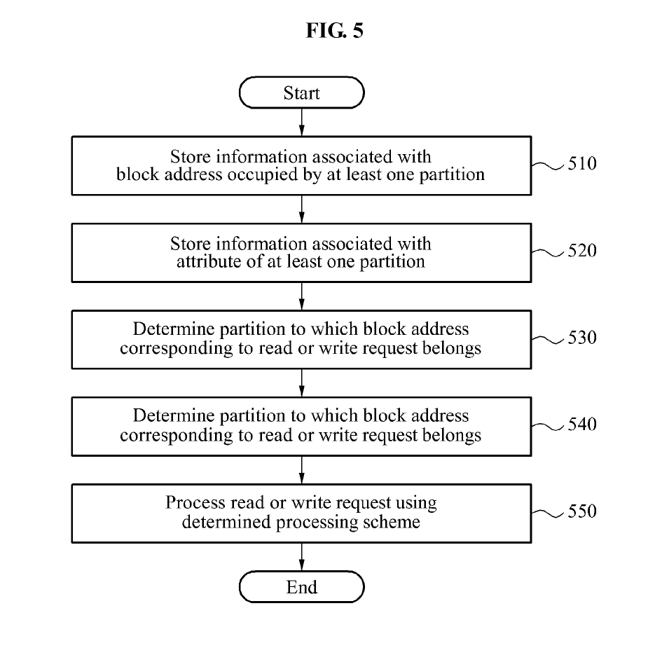

FIG. 5 is a flowchart illustrating a method of operating a storage device provided with at least one disk in a storage system including the storage device and a host according to an exemplary embodiment of the present invention.

Referring to FIG. 5, in operation 510, the storage device according to an exemplary embodiment of the present invention may store information associated with block addresses occupied by each of at least one partition of at least one disk.

In operation 520, the storage device may store information associated with an attribute of each of the at least one partition of the at least one disk.

In operation 530, each time the storage device receives a read or write request from a host, the storage device may determine a partition, to which a block address corresponding to the read or write request belongs, among the at least one partition.

In operation 540, the storage device may adaptively determine a processing scheme of the read or write request based on an attribute of the partition to which the block address corresponding to the read or write request belongs. The storage device may obtain the attribute of the partition to which the block address corresponding to the read or write request belongs, from the information associated with the attribute of the at least one partition stored in the storage device.

In operation 550, the storage device may process the read or write request using the determined processing scheme.

Hereinabove, the method of operating the storage device according to the present invention is described. The disclosure provided through the exemplary embodiments of FIGS. 1 through 4 described in the foregoing may be applied to the method of operating the storage device, and thus a further detailed description is omitted herein.

The methods described above may be recorded, stored, or fixed in one or more non-transitory computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of non-transitory computer-readable media include magnetic media such as hard discs, floppy discs, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa. In addition, a non-transitory computer-readable storage medium may be distributed among computer systems connected through a network and non-transitory computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1. A method of operating a storage device in a storage system comprising a host and the storage device provided with at least one disk, the method comprising:
storing information associated with an attribute for each of at least one partition of the at least one disk;
determining a partition to which a block address corresponding to a read or write request received from the host belongs among the at least one partition; and
adaptively determining a processing scheme of the read or write request based on an attribute of the partition to which the block address corresponding to the read or write request belongs.

2. The method of claim 1, further comprising:
pre-storing information associated with block addresses occupied by each of the at least one partition.

3. The method of claim 2, wherein the pre-storing of the information associated with the block addresses occupied by each of the at least one partition comprises, in a case in which a write request to a partition table is received, obtaining the information associated with the block addresses for each of the at least one partition based on data recorded corresponding to the write request to the partition table.

4. The method of claim 1, wherein the storing of the information associated with the attribute of each for the at least one partition of the at least one disk comprises receiving user settings associated with the attribute for each of the at least one partition from the host.

5. The method of claim 1, wherein the information associated with the attribute for each of the at least one partition comprises information associated with a weight value assigned to at least one of a data reliability, a processing speed, and a capacity for each of the at least one partition information.

6. The method of claim 1, wherein the adaptively determining of the processing scheme of the read or write request comprises determining whether to replicate and store data corresponding to the write request in different two locations of the partition to which the block address corresponding to the write request belongs, based on a weight value for a data reliability of the partition to which the block address corresponding to the write request belongs.

7. The method of claim 1, wherein the adaptively determining of the processing scheme of the read or write request comprises, in a case in which the storage device comprises an MLC flash memory, determining whether to operate the MLC flash memory in a single level cell (SLC) mode or an MLC mode, based on a weight value for a data reliability and a processing speed of the partition to which the block address corresponding to the read or write request belongs.

8. The method of claim 1, wherein the adaptively determining of the processing scheme of the read or write request comprises determining an address mapping scheme based on a weight value for sequential read and write and random read and write of the partition to which the block address corresponding to the read or write request belongs.

9. A non-transitory computer-readable medium comprising a program for instructing a computer to perform the method of claim 1.

10. A storage device in a storage system comprising a host and the storage device provided with at least one disk, the storage device comprising:
a storage module to store information associated with an attribute for each of at least one partition of the at least one disk; and
a control module to determine a partition to which a block address corresponding to a read or write request received from the host belongs among the at least one partition, and to adaptively determine a processing scheme of the read or write request based on an attribute of the partition to which the block address corresponding to the read or write request belongs.

11. The storage device of claim 10, wherein the storage module pre-stores information associated with block addresses occupied by each of the at least one partition.

12. The storage device of claim 11, wherein the storage module obtains, when a write request to a partition table is received, the information associated with the block addresses for each of the at least one partition based on data recorded corresponding to the write request to the partition table.

13. The storage device of claim 10, wherein the storage module receives user settings associated with the attribute for each of the at least one partition from the host.

14. The storage device of claim 10, wherein the information associated with the attribute for each of the at least one partition comprises information associated with a weight value assigned to at least one of a data reliability, a processing speed, and a capacity for each of the at least one partition information.

15. The storage device of claim 10, wherein the control module determines whether to replicate and store data corresponding to the write request in different two locations of the partition to which the block address corresponding to the write request belongs, based on a weight value for a data reliability of the partition to which the block address corresponding to the write request belongs.

16. The storage device of claim 10, wherein the control module determines, in a case in which the storage device comprises a multi level cell (MLC) flash memory, whether to operate the MLC flash memory in a single level cell (SLC) mode or an MLC mode, based on a weight value for a data reliability and a processing speed of the partition to which the block address corresponding to the read or write request belongs.

17. The storage device of claim 10, wherein the control module determines an address mapping scheme based on a weight value for sequential read and write and random read and write of the partition to which the block address corresponding to the read or write request belongs.
